(19) United States
(12) Patent Application Publication
(10) Pub. No.: US 2008/0309808 A1
(43) Pub. Date: Dec. 18, 2008

(54) METHOD OF DRIVING CCD SOLID-STATE IMAGE PICKUP DEVICE, AND IMAGE PICKUP APPARATUS

(76) Inventors: Daisuke KUSUDA, Kurokawa-gun (JP); Hirokazu Kobayashi, Saitama-shi (JP); Kazuya Oda, Kurokawa-gun (JP)

Correspondence Address: BIRCH STEWART KOLASCH & BIRCH, PO BOX 747, FALLS CHURCH, VA, 22040-0747, US

(21) Appl. No.: 12/140,724

(22) Filed: Jun. 17, 2008

(30) Foreign Application Priority Data
Jun. 18, 2007 (JP) P2007-160199
Sep. 28, 2007 (JP) P2007-256224
Sep. 28, 2007 (JP) P2007-256226
Sep. 28, 2007 (JP) P2007-256227

(51) Int. Cl. H04N 5/335

(52) U.S. Cl. 348/302; 348/E05.091

(57) ABSTRACT

A method of driving a CCD solid-state image pickup device, which performs multiplication driving on the signal charges, the method including: reading out signal charges from a plurality of photoelectric converting elements that are arranged in a two-dimensional array-like pattern to a charge transfer path that is disposed in parallel to a photoelectric converting element column of the photoelectric converting elements; and applying a multiplying pulse to a multiplying electrode among transfer electrodes constituting the charge transfer path, wherein an electrode, which is set as the multiplying electrode among the transfer electrodes, is periodically changed.

### BACKGROUND OF THE INVENTION

1. Field of the Invention

The present invention relates to a method of driving a CCD (Charge Coupled Device) solid-state image pickup device which performs multiplication driving on signal charges, and also to an image pickup apparatus.

2. Background Art

FIG. 21 is a diagram illustrating a CCD solid-state image pickup device. FIG. 21A shows a solid-state image pickup device of a so-called honeycomb pixel arrangement in which the arrangement of even-row pixels (photoelectric converting elements (photodiodes: PDs)) 12 formed in a surface portion of a semiconductor substrate is staggered by ½ pitch from that of odd-row pixels, and FIG. 21B shows a solid-state image pickup device in which pixels are arranged in a square lattice pattern.

A vertical charge transfer path (VCCD) 11 is disposed adjacent to each pixel column. A horizontal charge transfer path (HCCD) 13 is disposed along end portions of the vertical charge transfer paths 11. An amplifier 14 which outputs a voltage signal corresponding to the signal charge amount as a taken-image signal is disposed in an output end portion of the horizontal charge transfer path 13.

FIG. 22 is an enlarged view of the pixels shown in FIG. 21. In each pixel 12, two transfer electrodes are adjacently disposed. In the illustrated example, the lower transfer electrode (on the side of the horizontal charge transfer path) functions also as a readout electrode.

FIG. 23 is a view exemplarily showing the manner in which a detected charge (signal charge) is read out from the pixel 12 to the vertical charge transfer path 11, and the signal charge is transferred to the horizontal charge transfer path 13. In state T0, a signal charge (electrons) 16 which is read out to under a readout electrode V2 is stored in a potential well (charge packet) 17 that is formed under the readout electrode V2.

The charge packet expanding and contracting operations in which the charge packet 17 expands to under electrodes V2, V3 in state T1, contracts under the electrode V3 in next state T2, expands to under electrodes V3, V4 in next state T3, contracts to under the electrode V4 in next state T4, and so on are repeatedly performed, thereby transferring the signal charge 16 to the horizontal charge transfer path 13. A driving pulse for expanding and contracting a charge packet, i.e., a vertical transfer pulse is formed by, for example, voltages of 0 V and −8 V.

In the example, the charge packet expands and contracts in the sequence of one electrode→two electrodes→one electrode→. . . . Alternatively, the operations may be performed in various modes such as three electrodes→four electrodes→three electrodes→. . . .

In recent CCD solid-state image pickup devices, element miniaturization is advancing, and the saturated charge amount of each pixel is being reduced. When highly sensitive imaging is performed on a dark scene by such a device, the signal charge amount stored in each pixel is very small. Therefore, signal amplification is required. However, the floating diffusion amplifier (FDA) 14 and subsequent stage circuits which are disposed in the output stage of the CCD solid-state image pickup device are susceptible to noises. Even when signal amplification is performed in the output stage, it is impossible to obtain an amplification output of a high S/N ratio.

Therefore, signal amplification is preferably performed not in the output stage of the CCD solid-state image pickup device, but in the upstream side of a signal charge transfer path. In a prior art technique disclosed in JP-A-2002-290836 (the term “JP-A” as used herein means an “unexamined published Japanese patent application”) below, signal amplification is performed on the vertical charge transfer path 11 which is close to the pixel 12 generating a signal charge. The signal amplification is performed by using the impact ionization phenomenon.

FIG. 24 is a chart showing the manner in which signal amplification is performed on the vertical charge transfer path 11. The signal amplification is performed before the signal charge transfer which has been described with reference to FIG. 23. In the illustrated example, a signal charge is once accumulated in a charge packet 18 which is formed under electrodes V1, V2, V3, V4 (state T1), and the signal charge is temporarily confined in a charge packet 19 which is formed under electrodes V6, V7 (state T2). Then, another charge packet 20 is formed under the empty electrodes V2, V3, V4 (state T3). In the charge packet 20, a potential well 21 under the middle electrode V3 is formed deeper.

In next state T4, when the barrier under the electrode V5 between the charge packets 19, 20 is lowered, signal charges in the charge packet 19 drain into the deep potential well 21, and the amount of electrons is multiplied by the avalanche effect.

Even in the case where the multiplication factor of one electron multiplication is very small such as “1.01”, when electron multiplication is repeated 100 times, for example, the total multiplication factor is 2.7 times. In state T5, therefore, the multiplied signal charge is moved into the charge packet 19 which is formed under electrodes V6, V7, and the change of states of T3→T4→T5→T3→ . . . is again repeated, whereby a desired multiplication factor is obtained.

In the case where electron multiplication is performed, a deep potential well must be formed under the electrode V3 which has been described with reference to FIG. 16, and a high voltage is applied to the electrode V3 in each electron multiplication. The voltage is approximately as high as the readout voltage (for example, 15 V) which is applied when a signal charge is read out from the pixel 12 to the vertical charge transfer path 11. This high voltage is repeatedly applied to a specific electrode.

Therefore, a CCD solid-state image pickup device in which electron multiplication is performed must be produced by a material having a high physical resistance so that, even when a high voltage is repeatedly applied to a specific electrode, the specific electrode is not electrostatically broken. When semiconductors and electrodes are configured by a material or structure which is highly resistant, however, there arises a problem in that the production cost is increased.

In the case where electron multiplication is performed, a deep potential well must be formed under the electrode V3 which has been described with reference to FIG. 13, and a high voltage is applied to the electrode V3 in each electron multiplication. As described above, electron multiplication must be repeatedly performed, for example, 100 times or 50 times. Therefore, the time required for one electron multiplication must be short. However, there is a problem in that, in a configuration where a high voltage is simply applied to the electrode V3 to form a deep potential well, all electrodes in the packet 19 cannot be rapidly moved into the deep potential well 15.

In the case where the deep potential well 15 is formed in order to perform electron multiplication, and electrons are moved into the potential well 15, when the movement control is not suitably conducted, electrons which jump over the place where the potential well 15 is formed are generated. The electrons are not subjected to electron multiplication, thereby producing a problem in that realization of highly accurate electron multiplication is inhibited by the electros.

Although the accuracy of the technique for producing a semiconductor device has been enhanced, it is difficult to cause the electron multiplication factor which is obtained by repeating electron multiplication 100 times in a certain electrode place, to accurately coincide with that which is obtained by repeating electron multiplication 100 times in another electrode place. Namely, an electron multiplication factor dispersion that is inherent in a solid-state image pickup device is produced. There arises a problem in that this dispersion appears as fixed pattern noises and the quality of a taken image is impaired.

### SUMMARY OF THE INVENTION

It is a first object of the invention to provide a method of driving a CCD solid-state image pickup device, and image pickup apparatus in which the production cost can be decreased, and the reliability of a solid-state image pickup device can be improved.

It is a second object of the invention to provide a method of driving a CCD solid-state image pickup device, and image pickup apparatus in which electron multiplication driving can be performed for a short time, generation of electrons that are not electron-multiplied is suppressed to enable accurate electron multiplication to be realized, and an electron multiplication factor dispersion that is inherent in an image pickup device can be suppressed.
(1) According to a first aspect of the present invention, a method of driving a CCD solid-state image pickup device, which performs multiplication driving on the signal charges, the method including: reading out signal charges from a plurality of photoelectric converting elements that are arranged in a two-dimensional array-like pattern to a charge transfer path that is disposed in parallel to a photoelectric converting element column of the photoelectric converting elements; and applying a multiplying pulse to a multiplying electrode among transfer electrodes constituting the charge transfer path, wherein an electrode, which is set as the multiplying electrode among the transfer electrodes, is periodically changed.
(2) The method as described in the item (1), wherein at least one of rising and falling edges of the multiplying pulse is more inclined than an edge of A read pulse which is applied to a readout electrode in a case where signal charges are read out from the photoelectric converting elements.
(3) The method as described in the item (1) or (2), wherein the multiplying pulse has a height being lower than a height of a read pulse applied in the reading out of the signal charge.
(4) The method as described in any one of the items (1) to (3), wherein a transfer electrode adjacent to a photoelectric converting element from which a signal charge is read out, and which is empty is used as the multiplying electrode.
(5) The method as described in any one of the item (1) to (3), wherein a transfer electrode, which is not a readout electrode adjacent to a photoelectric converting element that is not an object of reading a signal charge in a case where a motion picture is read out, is used as the multiplying electrode.
(6) According to a second aspect of the present invention, a method of driving a CCD solid-state image pickup device which performs multiplication driving on the signal charges, the method including: reading out signal charges from a plurality of photoelectric converting elements that are arranged in an array-like pattern to a charge transfer path that is disposed in parallel to a photoelectric converting element column of the photoelectric converting elements; and applying a multiplying pulse to a multiplying electrode among transfer electrodes constituting the charge transfer path, wherein at least one of rising and falling edges of the multiplying pulse is inclined.
(7) The method as described in the item (6), wherein the multiplying pulse has a height being lower than a height of a read pulse which is applied in a case where signal charges are read out from the photoelectric converting elements to the charge transfer path.
(8) According to a third aspect of the present invention, a method of driving a CCD solid-state image pickup device which performs multiplication driving on signal charges, the method including: reading out the signal charges from a plurality of photoelectric converting elements that are arranged in an array-like pattern to a charge transfer path that is disposed in parallel to a photoelectric converting element column of the photoelectric converting elements; and applying a multiplying pulse to a multiplying electrode among transfer electrodes constituting the charge transfer path, wherein a transfer electrode adjacent to a photoelectric converting element from which a signal charge is read out, and which is empty is used as the multiplying electrode.
(9) According to a fourth aspect of the present invention, a method of driving a CCD solid-state image pickup device, which performs multiplication driving on the signal charges, the method including: reading out signal charges from a plurality of photoelectric converting elements that are arranged in a two-dimensional array-like pattern to a charge transfer path that is disposed in parallel to a photoelectric converting element column of the photoelectric converting elements; and applying a multiplying pulse to a multiplying electrode among transfer electrodes constituting the charge transfer path, wherein a transfer electrode, which is not a transfer electrode adjacent to a photoelectric converting element that is not an object of reading a signal charge in a case where a motion picture is read out, is used as the multiplying electrode.
(10) According to a fifth aspect of the present invention, an image pickup apparatus includes: a CCD solid-state image pickup device, and an image pickup device driving unit that produces a multiplying pulse according to claim 1, and supplies the multiplying pulse to the CCD solid-state image pickup device.
(11) The image pickup apparatus as described in the item (10) wherein the CCD solid-state image pickup device is a line sensor.
(12) The image pickup apparatus as described in the item (10), wherein the CCD solid-state image pickup device is an area sensor.
(13) The image pickup apparatus as described in the item (12), wherein a pixel arrangement of the CCD solid-state image pickup device is a honeycomb pixel arrangement.
(14) The image pickup apparatus as described in the item (12), wherein a pixel arrangement of the CCD solid-state image pickup device is a square lattice arrangement.
(15) According to a sixth aspect of the present invention, a method of driving a CCD solid-state image pickup device, which performs multiplication driving on signal charges, the method including: reading out signal charges from a plurality of photoelectric converting elements that are arranged in a two-dimensional array-like pattern to a charge transfer path that is disposed in parallel to a photoelectric converting element column of the photoelectric converting elements; storing the signal charges in a first potential well between first and second potential barriers formed in the charge transfer path; forming a multiplication potential well which is deeper than the first potential well by applying a multiplication voltage to a multiplication electrode, which is a predetermined electrode which is among transfer electrodes constituting the charge transfer path and is at a position beyond the first potential barrier; and eliminating the first potential barrier to cause the signal charges in the first potential well to fall into the multiplication potential well, wherein a voltage, which is applied to the transfer electrode that forms the second potential barrier, is controlled so that, in a case where the first potential barrier is eliminated to cause the signal charges to fall into the multiplication potential well, the signal charges are pushed toward the multiplication potential well by using the second potential barrier.
(16) The method as described in the item (15), wherein, in the pushing of the signal charges, a voltage, which is applied to the transfer electrode to form a barrier end portion of the second potential barrier on the side of the signal charges, is controlled to make a barrier height of the barrier end portion higher than a barrier height of the second potential barrier.
(17) The method as described in the item (15) or (16), wherein, in the pushing of the signal charges, a voltage, which is applied to the transfer electrode to define a depth of a well between a barrier end portion of the second potential barrier on the side of the signal charges and the multiplication potential well, is controlled to raise the depth of the well to a level which is lower than the second potential barrier.
(18) The method as described in any one of the items (15) to (17), wherein an empty second potential well is formed in a place which is beyond the multiplication potential well as viewed from the first potential well.
(19) The method as described in the item (16), wherein a high voltage for forming the multiplication potential well is not applied to the transfer electrode for forming the second potential well.
(20) The method as described in the item (18) or (19), wherein the multiplied signal charges and a signal charge in the second potential well are added to each other.
(21) The method as described in any one of the item (18) to (20), wherein, after the multiplied signal charges and a signal charge in the second potential well are added to each other, the multiplication is again performed.
(22) The method as described in any one of the items (15) to (21), wherein, in a case where successive transfer electrodes Vi, Vi+1, Vi+2, . . . , Vi+j to which transfer pluses φVi, φVi+1, φVi+2, . . . , φVi+j are respectively applied are set as a transfer electrode group for one line, i and j are arbitrary, and the transfer electrode group is repeatedly disposed over a plurality of lines along the charge transfer path, after the multiplication potential well is formed in a certain one of the lines to perform the multiplication and the signal charges after the multiplication are transferred to a next line in a direction of the transfer, the multiplication potential well is formed in the next line and the multiplication is again performed.
(23) The method as described in any one of the items (15) to (22), wherein, in a case where successive transfer electrodes Vi, Vi+1, Vi+2, . . . , Vi+j to which transfer pluses φVi, φVi+1, φVi+2, . . . , φVi+j are respectively applied are set as a transfer electrode group for one line, i and j are arbitrary, and the transfer electrode group is repeatedly disposed over a plurality of lines along the charge transfer path, after the multiplication potential well is formed in a certain one of the lines to perform the multiplication, the multiplication is repeatedly performed while switching over the multiplication electrode which forms the multiplication potential well, in the lines.
(24) According to a seventh aspect of the present invention, an image pickup apparatus includes: a CCD solid-state image pickup device; and an image pickup device driving unit that drives the CCD solid-state image pickup device by a driving method according to any one of the items (15) to (23).
(25) According to a eighth aspect of the present invention, a method of driving a CCD solid-state image pickup device, which performs multiplication driving on signal charges, the method including: reading out signal charges from a plurality of photoelectric converting elements that are arranged in a two-dimensional array-like pattern to a charge transfer path that is disposed in parallel to a photoelectric converting element column of the photoelectric converting elements; storing the signal charges in a first potential well between first and second potential barriers formed in the charge transfer path, forming a multiplication potential well which is deeper than the first potential well by applying a multiplication voltage to the multiplication electrodes which is a predetermined electrode which is among transfer electrodes constituting the charge transfer path and is at a position beyond the first potential barrier; and eliminating the first potential barrier to cause the signal charges in the first potential well to fall into the multiplication potential well, wherein the falling of the signal charges is performed by forming an empty second potential well in a place which is beyond the multiplication potential well as viewed from the first potential well.
(26) The method as described in the item (25), wherein a high voltage which forms the multiplication potential well is not applied to the transfer electrode which forms the second potential well.
(27) The method as described in the item (25) or (26), wherein the multiplied signal charges and a signal charge in the second potential well are added to each other.
(28) The method as described in any one of the items (25) to (27), wherein, after the multiplied signal charges and a signal charge in the second potential well are added to each other, the multiplication is again performed.
(29) The method as described in any one of the items (25) to (28), wherein, in a case where successive transfer electrodes Vi, Vi+1, Vi+2, . . . , Vi+j to which transfer pluses φVi, φVi+1, φVi+2, . . . , φVi+j are respectively applied are set as a transfer electrode group for one line, i and j are arbitrary, and the transfer electrode group is repeatedly disposed over a plurality of lines along the charge transfer path, after the multiplication potential well is formed in a certain one of the lines to perform the multiplication and the signal charges after the multiplication are transferred to a next line in a direction of the transfer, the multiplication potential well is formed in the next line and the multiplication is again performed.
(30) The method as described in any one of the items (25) to (29), wherein, in a case where successive transfer electrodes Vi, Vi+1, Vi+2, . . . , Vi+j to which transfer pluses φVi, φVi+1, φVi+2, . . . , φVi+j are respectively applied are set as a transfer electrode group for one line, i and j are arbitrary, and the transfer electrode group is repeatedly disposed over a plurality of lines along the charge transfer path, after the multiplication potential well is formed in a certain one of the lines to perform the multiplication, the multiplication is repeatedly performed while switching over the multiplication electrode which forms the multiplication potential well, in the lines.
(31) According to a ninth aspect of the present invention, an image pickup apparatus includes: a CCD solid-state image pickup device; and an image pickup device driving unit that drives the CCD solid-state image pickup device by a driving method according to any one of the items (25) to (30).
(32) According to a tenth aspect of the present invention, a method of driving a CCD solid-state image pickup device, which performs multiplication driving on signal charges, the method including: reading out signal charges from a plurality of photoelectric converting elements that are arranged in a two-dimensional array-like pattern to a charge transfer path that is disposed in parallel to a photoelectric converting element column of the photoelectric converting elements; storing the signal charges in a first potential well between first and second potential barriers formed in the charge transfer path; forming a multiplication potential well which is deeper than the first potential well by applying a multiplication voltage to the multiplication electrode, which is a predetermined electrode which is among transfer electrodes constituting the charge transfer path and is at a position beyond the first potential barrier; and eliminating the first potential barrier to cause the signal charges in the first potential well to fall into the multiplication potential well, wherein, in a case where successive transfer electrodes Vi, Vi+1, Vi+2, . . . , Vi+j to which transfer pluses φVi, φVi+1, φVi+2, . . . , φVi+j are respectively applied are set as a transfer electrode group for one line, i and j are arbitrary, and the transfer electrode group is repeatedly disposed over a plurality of lines along the charge transfer path, after the multiplication potential well is formed in a certain line to perform the multiplication and the signal charges after the multiplication are transferred to a next line in a direction of the transfer, the multiplication potential well is formed in the next line and the multiplication is again performed.
(33) The method as described in the item (32), wherein, after the multiplication potential well is formed in a certain one of the lines to perform the multiplication, the multiplication is repeatedly performed while switching over the multiplication electrode which forms the multiplication potential well, in the lines.
(34) According to an eleventh aspect of the present invention, an method of driving a CCD solid-state image pickup device, which performs multiplication driving on signal charges, including: reading out signal charges from a plurality of photoelectric converting elements that are arranged in a two-dimensional array-like pattern to a charge transfer path that is disposed in parallel to a photoelectric converting element column of the photoelectric converting elements; storing the signal charges in a first potential well between first and second potential barriers formed in the charge transfer path; forming a multiplication potential well which is deeper than the first potential well by applying a multiplication voltage to the multiplication electrode, which is a predetermined electrode which is among transfer electrodes constituting the charge transfer path and is at a position beyond the first potential harrier; and eliminating the first potential barrier to cause the signal charges in the first potential well to fall into the multiplication potential well, wherein, in a case where successive transfer electrodes Vi, Vi+1, Vi+2, . . . , Vi+j to which transfer pluses φVi, φVi+1, φVi+2, . . . , φVi+j are respectively applied are set as a transfer electrode group for one line, i and j are arbitrary, and the transfer electrode group is repeatedly disposed over a plurality of lines along the charge transfer path, after the multiplication potential well is formed in a certain one of the lines to perform the multiplication, the multiplication is repeatedly performed while switching over the multiplication electrode which forms the multiplication potential well, in the lines.
(35) According to a twelfth aspect of the present invention, an image pickup apparatus includes: a CCD solid-state image pickup device; and an image pickup device driving unit that drives the CCD solid-state image pickup device by a driving method according to any one of the items (32) to (34).

According to the present invention, a stress which is due to application of a multiplying pulse of high voltage, and which is applied to a semiconductor or an electrode is relieved. Therefore, the resistance of a CCD solid-state image pickup device to a multiplying pulse can be enhanced, and the reliability of the CCD solid-state image pickup device can be improved.

According to the present invention, electron multiplication driving can be performed for a short time, generation of electrons that are not electron-multiplied is suppressed to enable accurate electron multiplication to be realized, and an electron multiplication factor dispersion that is inherent in an image pickup device can be suppressed.

### BRIEF DESCRIPTION OF THE DRAWINGS

The invention disclosed herein will be understood better with reference to the following drawings of which:

FIG. 1 is a diagram illustrating a method of driving a CCD solid-state image pickup device of a first embodiment of the invention;

FIG. 2 is a chart showing the manner in which potential wells formed under transfer electrodes are changed in the driving method shown in FIG. 1;

FIG. 3 is a chart showing an example of a driving pulse of a vertical charge transfer path which realizes the driving method shown in FIGS. 1 and 2;

FIG. 4 is a diagram illustrating a method of driving a CCD solid-state image pickup device of a second embodiment of the invention;

FIG. 5 is a chart showing the manner in which potential wells formed under transfer electrodes are changed in the driving method shown in FIG. 4;

FIG. 6 is a chart showing an example of a driving pulse of a vertical charge transfer path which realizes the driving method shown in FIGS. 4 and 5;

FIG. 7 is a view illustrating a method of driving a CCD solid-state image pickup device of a third embodiment of the invention;

FIG. 8 is a view illustrating a method of driving a CCD solid-state image pickup device of a fourth embodiment of the invention;

FIG. 9 is a chart showing an example of a pulse of driving a vertical charge transfer path in a CCD solid-state image pickup device of a sixth embodiment of the invention;

FIG. 10 is a chart showing an example of a pulse of driving a vertical charge transfer path in a CCD solid-state image pickup device of a ninth embodiment of the invention;

FIG. 11 is a diagram showing an example of a pulse of driving a vertical charge transfer path in a CCD solid state image pickup device of a twelfth embodiment of the invention;

FIG. 12 is a block diagram of an image pickup device of a thirteenth embodiment of the invention;

FIG. 13 is a timing chart illustrating a driving method of the fourteenth embodiment of the invention;

FIG. 14 is a timing chart showing a first modification of the driving method shown in FIG. 13;

FIG. 15 is a timing chart showing a second modification of the driving method shown in FIG. 13;

FIG. 16 is a timing chart illustrating a driving method of a fifteenth embodiment of the invention;

FIG. 17 is a timing chart showing a modification of the driving method shown in FIG. 16;

FIG. 18 is a chart illustrating a driving method of a sixteenth embodiment of the invention;

FIG. 19 is a chart illustrating a driving method of a seventeenth embodiment of the invention;

FIG. 20 is a diagram illustrating the effect of the seventeenth embodiment shown in FIG. 19;

FIG. 21A is a surface diagram of a CCD solid-state image pickup device of a honeycomb pixel arrangement, and FIG. 21B is a surface diagram of a CCD solid-state image pickup device of a square lattice pattern;

FIG. 22 is a diagram illustrating a readout electrode of a CCD solid-state image pickup device;

FIG. 23 is a chart showing the manner of vertical charge transfer in a CCD solid-state image pickup device; and

FIG. 24 is a chart illustrating the electron multiplication driving.

### DETAILED DESCRIPTION OF THE INVENTION

Hereinafter, embodiments of the invention will be described with reference to the accompanying drawings.

### First Embodiment

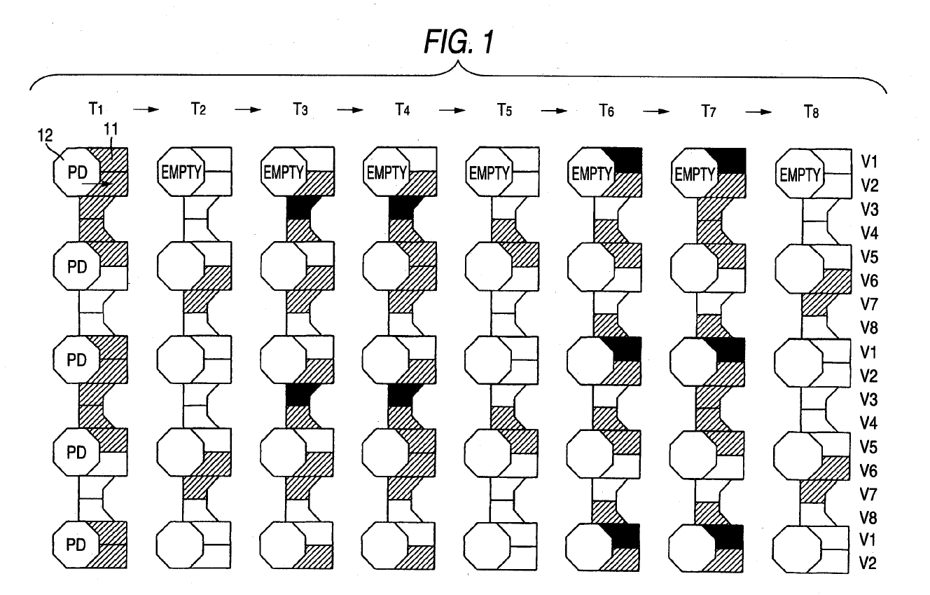

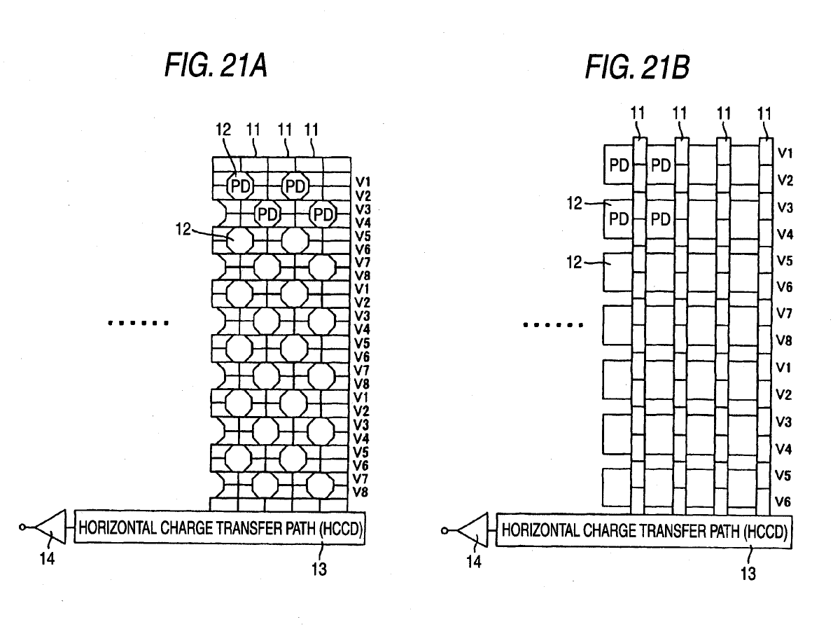

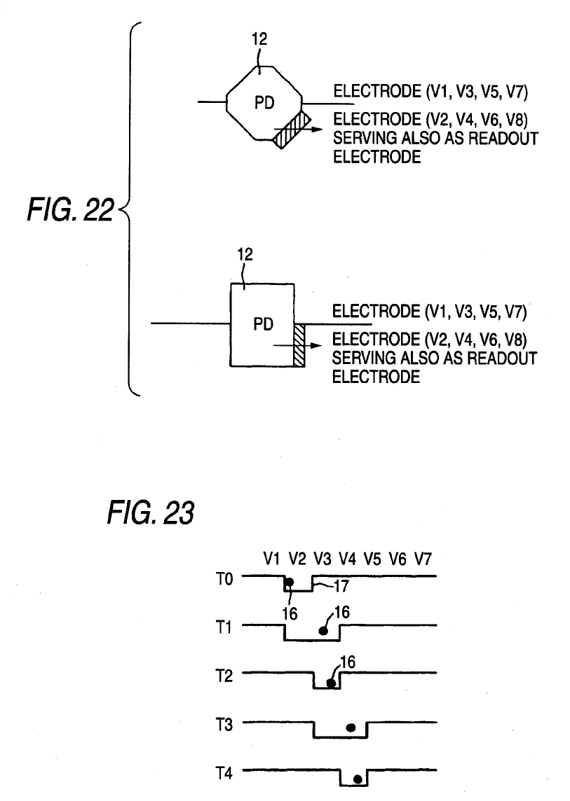

FIG. 1 is a diagram illustrating a method of driving a CCD solid-state image pickup device of a first embodiment of the invention. The illustrated solid-state image pickup device is an image pickup device which has a honeycomb pixel arrangement shown in FIG. 21A. The figure shows a change of states (T1 to T8) of one pixel (PD) column and vertical charge transfer path of the device.

Among the illustrated transfer electrodes adjacent to the pixels PD, electrodes V2, V6 are transfer electrodes which function also as a readout electrode. When a high voltage is applied to the readout electrodes, accumulated charges in pixels PD are read out to the vertical charge transfer path. As shown in FIG. 21A, in the honeycomb pixel arrangement, the pixel column next to the pixel column shown in FIG. 1 is staggered by ½ pitch. In the next pixel column, therefore, the readout electrodes are electrodes V4, V8.

When a high voltage is applied to the electrodes V4, V8, accumulated charges in the pixels are read out to the vertical charge transfer path. In the image pickup device, even when a high voltage is applied to electrodes V1, V3, V5, V7 other than the readout electrodes, therefore, signal charges are not read out to the vertical charge transfer path.

In FIG. 1, a low potential (for example, −8 volts) VL is applied to the vertical transfer electrodes indicated by a hollow area (a potential well is eliminated), an intermediate potential (for example, 0 volt) VM is applied to the electrodes indicated by a hatched area (an intermediate-depth potential well is formed), and a high potential (for example, +15 volts) VH is applied to the electrodes indicated by a solid area (a deep potential well is formed).

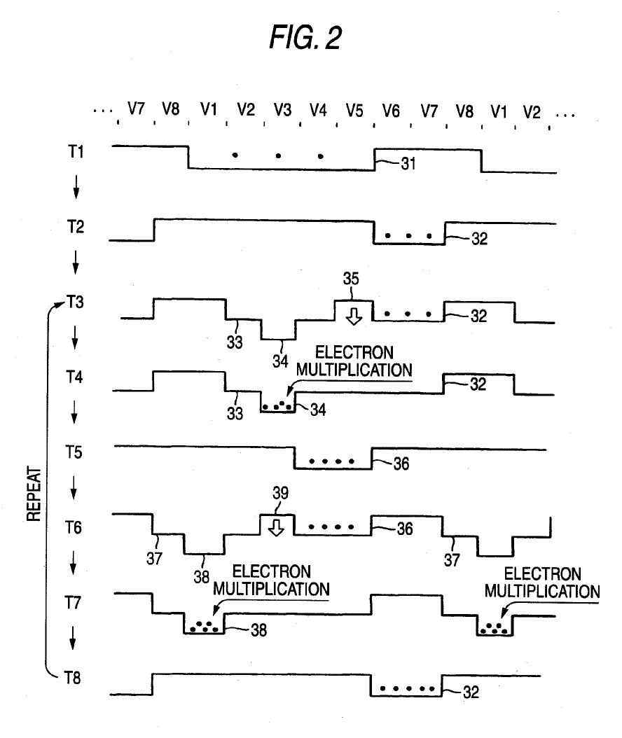

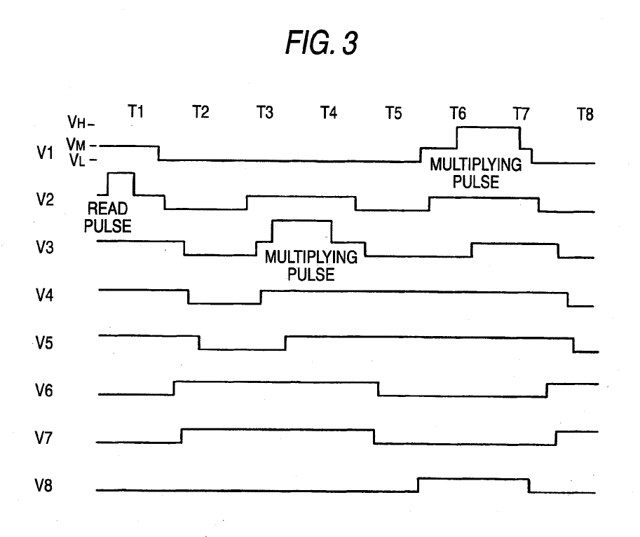

FIG. 2 is a chart showing the manner in which potential wells are changed in accordance with the change of the transfer electrode applied voltage shown in FIG. 1, and FIG. 3 is a chart showing a driving pulse applied to the transfer electrodes V1 to V8.

Referring to FIG. 2, in state T1 in the embodiment, an intermediate-depth potential well 31 is formed under the electrodes V1, V2, V3, V4, V5. In this state, when the read pulse VH is applied to the electrode V2 for a short time, signal charges of the corresponding pixels in FIG. 3 are read out into the potential well 31. Although, at the moment the read pulse VH is applied to the electrode V2, only the potential well under the electrode V2 is deepened for a short time, an illustration of this phenomenon is omitted.

In next state T2, an intermediate-depth potential well 32 is formed under the electrodes V6, V7, and the potential well 31 under the electrodes V1, V2, V3, V4, V5 is eliminated in the sequence of the electrodes, so that the signal charges in the potential well 31 are moved and accumulated in the potential well 32.

In next state T3, a potential well 33 is formed under the electrodes V2, V3, V4. At this time, a high voltage (multiplying pulse) is applied to the middle electrode V3 to deepen a potential well 34 under the electrode V3.

In next state T4, when the voltage VM in applied to the electrode V5, a barrier 35 between the potential wells 32 and 33 disappears, and the signal charges in the potential well 32 are moved toward the deep potential well 34 to fall into the potential well 34.

The potential difference between the intermediate-depth potential well 32 and the deep potential well 34 is large. When signal charges (electrons) fall from the potential well 32 to the potential well 34, therefore, electron multiplication is caused by avalanche breakdown, and the number of electrons is increased.

In next state T5, an intermediate-depth potential well 36 is formed under the electrodes V5, V6, and the potential wells under the other electrodes V1, V2, V3, V4, V7, V8 are eliminated. Then, the signal charges which have been electron-multiplied are collected and accumulated in the potential well 36.

In next state T6, a potential well 37 is formed under the electrodes V8, V1, V2. At this time, a high voltage (multiplying pulse) is applied to the middle electrode V1 to deepen a potential well 38 under the electrode V1.

In next state T7, when the voltage VM is applied to the electrode V3, a barrier 39 between the potential wells 36 and 37 disappears, and the signal charges in the potential well 36 are moved toward the deep potential well 38 to fall into the potential well 38. As a result, electron multiplication is again caused, and the number of electrons is increased.

In next state T8, in the same manner as state T2, the signal charges are moved and accumulated in the potential well 32 formed under the electrodes V6, V7, and then the state is returned to state T3. Namely, states T3 to T8 which have been described above are repeated in a predetermined number of times to obtain a desired electron multiplication factor.

In the embodiment, as described above, the electrode to which the electron multiplying pulse that has a high voltage is applied is changed in the sequence of V3→V1→V3→V1→ . . . , or not fixed. Therefore, the resistance to repeated electron multiplication can be enhanced by the improvement in which the timing of driving the vertical charge transfer path is changed as described above, and the reliability of the solid-state image pickup device can be enhanced without increasing the production cost of the solid-state image pickup device.

In the embodiment, the electrode to which the electron multiplying pulse is applied is changed in the sequence of V3→V1→V3→V1→ . . . , or at each time when electron multiplication is performed one time. Alternatively, the interval of the electrode change may be periodically changed, or, for example, at each time when electron multiplication is performed five times, or at each time when electron multiplication is performed 100 times. There is a configuration where electron multiplication is not always performed, such as that where electron multiplication is required only when highly sensitive imaging is conducted in a digital camera or the like. In such a case, preferably, information of the electrode on which previous electron multiplication is performed is stored in a nonvolatile memory or the like, and the electrode on which the electron multiplying pulse in the present electron multiplication is to be applied is determined on the basis of the information.

### Second Embodiment

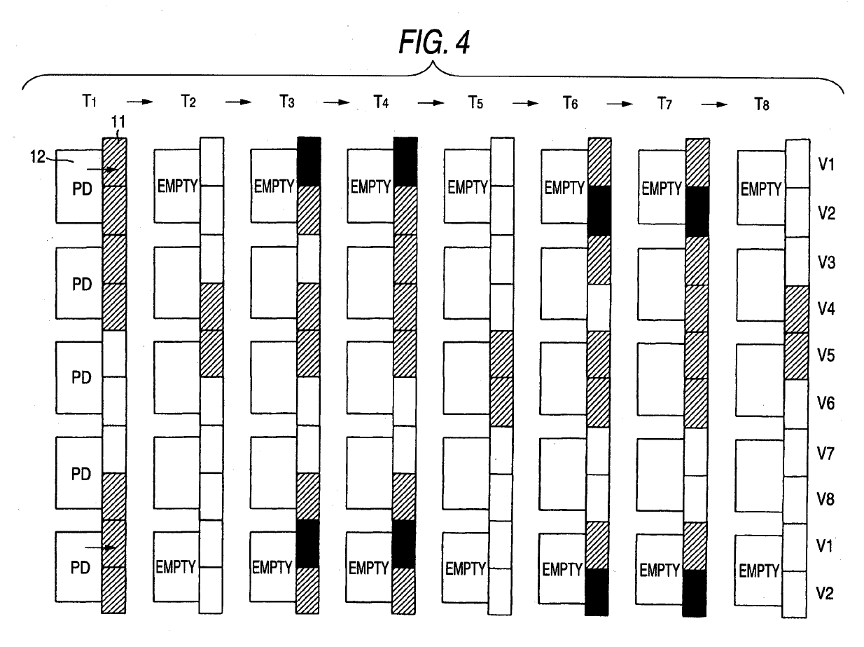

FIGS. 4 to 6 are diagrams illustrating a method of driving a CCD solid-state image pickup device of a second embodiment of the invention. The figures correspond to FIGS. 1 to 3 in the first embodiment, respectively. In the embodiment, a driving method similar to that of the first embodiment is applied to the CCD solid-state image pickup device shown in FIG. 21B.

In the illustrated example, among the transfer electrodes adjacent to the pixels PD, electrodes V1, V3, V5, V7 are transfer electrodes which function also as a readout electrode. When a high voltage is applied to the readout electrodes, accumulated charges in pixels PD are read out to the vertical charge transfer path. In a state where a signal charge is already read out from a corresponding pixel and the pixel is empty, even when a high voltage is applied to a readout electrode, however, no signal charge is read out.

In FIG. 4, the meanings of “hollow”, “hatched”, and “solid” in the vertical transfer electrodes are identical with those of the first embodiment.

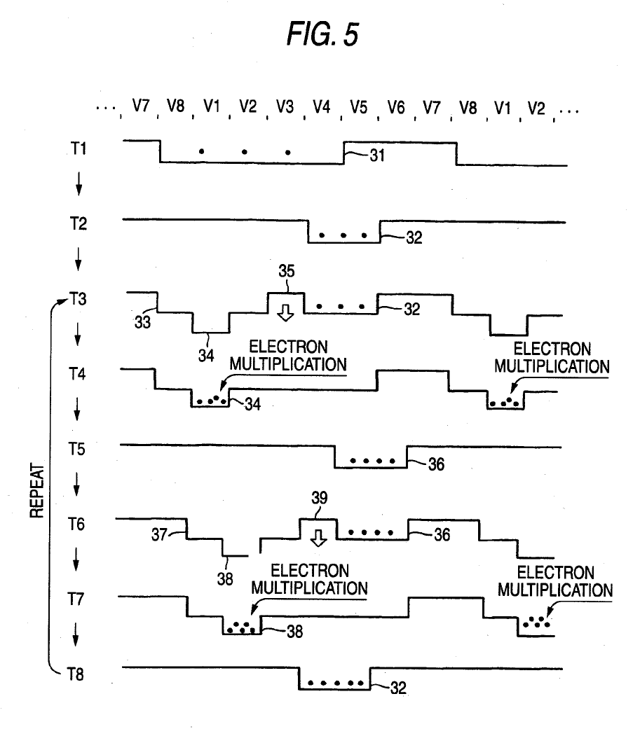

Referring to FIG. 5, in state T1 in the embodiment, the intermediate-depth potential well 31 is formed under the electrodes V8, V1, V2, V3, V4. In this state, when the read pulse VH is applied to the electrode V1 for a short time, signal charges of the corresponding pixels are read out into the potential well 31.

In next state T2, the intermediate-depth potential well 32 is formed under the electrodes V4, V5, and the potential well 31 under the electrodes V8, V1, V2, V3 is eliminated in the sequence of the electrodes, so that the signal charges in the potential well 31 are moved and accumulated in the potential well 32.

In next state T3, the potential well 33 is formed under the electrodes V8, V1, V2. At this time, a high voltage (multiplying pulse) is applied to the middle electrode VI to deepen the potential well 34 under the electrode V1. The electrode V1 is a readout electrode for the pixel. However, the signal charge is already read out from the pixel. Therefore, it is a matter of course that, even when the high voltage is applied to the electrode V1, no signal charge is read out from the pixel. Consequently, the electrode V1 can be used as an electrode for applying the multiplying pulse.

In next state T4, when the voltage VM is applied to the electrode V3, the barrier 35 between the potential wells 32 and 33 disappears, and the signal charges in the potential well 32 are moved toward the deep potential well 34 to fall into the potential well 34.

The potential difference between the intermediate-depth potential well 32 and the deep potential well 34 is large. When signal charges (electrons) fall from the potential well 32 to the potential well 34, therefore, electron multiplication is caused by avalanche breakdown, and the number of electrons is increased.

In next state T5, the intermediate-depth potential well 36 is formed under the electrodes V5, V6, and the potential wells under the other electrodes V1, V2, V3, V4, V7, V8 are eliminated. Then, the signal charges which have been electron-multiplied are collected and accumulated in the potential well 36.

In next state T6, the potential well 37 is formed under the electrodes V1, V2, V3. At this time, a high voltage (multiplying pulse) is applied to the middle electrode V2 to deepen the potential well 38 under the electrode V2.

In next state T7, when the voltage VM is applied to the electrode V4, the barrier 39 between the potential wells 36 and 37 disappears, and the signal charges in the potential well 36 are moved toward the deep potential well 38 to tall into the potential well 38. As a result, electron multiplication is again caused, and the number of electrons is increased.

In next state T8, in the same manner as state T2, the signal charges are moved and accumulated in the potential well 32 formed under the electrodes V4, V5, V6, and then the state is returned to state T3. States T3 to T8 which have been described above are repeated in a predetermined number of times to obtain a desired electron multiplication factor.

As described above, also in the CCD solid-state image pickup device in which pixels are arranged in a square lattice pattern, the electrode to which the electron multiplying pulse is applied is periodically changed or not fixed similarly with the first embodiment. Therefore, the resistance of the CCD solid-state image pickup device can be enhanced by the improvement of the method of driving the vertical charge transfer path.

### Third Embodiment

FIG. 7 is a view illustrating a method of driving a CCD solid-state image pickup device of a third embodiment of the invention. Similarly with the read pulse (TG) which is used for reading signal charges from pixels to the vertical charge transfer path, an electron multiplying pulse of high voltage is produced as a binary pulse voltage of, for example, 0 V (VM) and +15 V (VH).

When rising and falling edges of the electron multiplying pulse are steep (approximately vertical), however, the potential of a transfer electrode to which the electron multiplying pulse is applied is steeply changed, and an electric field applied to the transfer electrode and its vicinity is largely changed, thereby producing a possibility that the electrode and a semiconductor portion in the vicinity may be electrostatically broken. Moreover, the electron multiplying pulse is repeatedly applied many times. Even when electrostatic breakdown does not occur, therefore, the physical properties of the portions may he impaired.

In the embodiment, at least one of rising and falling edges of the electron multiplying pulse is inclined as shown in the lower portion of FIG. 7. In a CCD solid-state image pickup device, usually, edges of a driving pulse are approximately vertical as shown in the upper portion of FIG. 7. More precisely, however, edge portions of a pulse wave are slightly inclined under the influence of a capacitor and the like. In the embodiment, the edge(s) of the electron multiplying pulse is more inclined than edges of such a driving pulse, and, for example, edges of the read pulse (TG) which is applied to a readout electrode where a signal charge is to be read out from a photoelectric converting element.

Preferably, both the pulse rising and falling edges are provided with inclination (time width) of about several nanoseconds to produce an electron multiplying pulse which avoids a steep electric field change. The vertical charge transfer path is driven by the pulse.

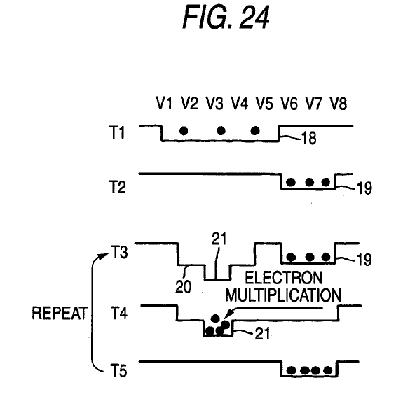

When the CCD solid-state image pickup device is driven as described above, even in the case where the transfer electrode V3 is fixed as the electrode to which the electron multiplying pulse is applied as described with reference to FIG. 24, the resistance of the image pickup device can be enhanced, and the reliability can be improved.

### Fourth Embodiment

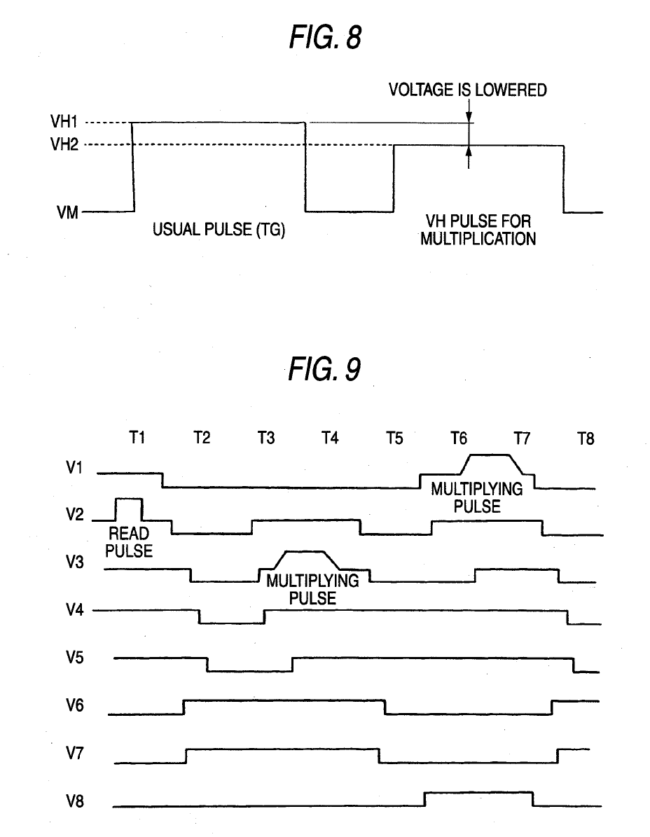

FIG. 8 is a view illustrating a method of driving a CCD solid-state image pickup device of a fourth embodiment of the invention. As described above, similarly with the read pulse (TG) which is used for reading signal charges from pixels to the vertical charge transfer path, an electron multiplying pulse of high voltage is produced as a binary pulse voltage of, for example, 0 V (VM) and +15 V (VH).

When the high voltage is applied to the transfer electrode for applying the electron multiplying pulse, an electric field applied to the transfer electrode and its vicinity is largely changed, thereby producing a possibility that the electrode and a semiconductor portion in the vicinity may be electrostatically broken. Moreover, the electron multiplying pulse is applied a very large number of times. Even when electrostatic breakdown does not occur, therefore, the physical properties of the portions may be impaired.

In the embodiment, as shown in FIG. 8, the height of the electron multiplying pulse is made lower than that of a usual read pulse. In the case where the height of a usual read pulse is 15 V, for example, the height of the electron multiplying pulse is lowered to about 12 V. According to the configuration, even in the case where the transfer electrode V3 is fixed as the electrode to which the electron multiplying pulse is applied as described with reference to FIG. 24, the resistance of the CCD solid-state image pickup device can be enhanced, and the reliability can be improved.

### Fifth Embodiment

A fifth embodiment of the invention is configured by combining the above-described third and fourth embodiments with each other. Namely, the height of the electron multiplying pulse is made lower than that of a read pulse, and at least one, more preferably both, of rising and falling pulse edges is inclined. According to the configuration, the resistance of the CCD solid-state image pickup device can be further enhanced.

### Sixth Embodiment

FIG. 9 is a chart illustrating a method of driving a CCD solid-state image pickup device of a sixth embodiment of the invention. The embodiment is configured by combining the above-described first and third embodiments with each other.

Namely, at least one, more preferably both, of rising and falling pulse edges of the multiplying pulse shown in FIG. 1 is inclined, whereby a driving pulse for the vertical charge transfer path shown in FIG. 9 is produced.

In the embodiment, the electrode to which the electron multiplying pulse is applied is not fixed, and the edge(s) of the electron multiplying pulse is inclined so that the electric field is gently changed. Therefore, the resistance of the CCD solid-state image pickup device is enhanced, and the reliability is improved.

### Seventh Embodiment

A seventh embodiment of the invention is configured by combining the above-described first and fourth embodiments with each other. Namely, the electrode to which the electron multiplying pulse is applied is not fixed, and the height of the electron multiplying pulse is made lower than that of a read pulse. Also according to the configuration, the resistance of the CCD solid-state image pickup device is enhanced, and the reliability is improved.

### Eighth Embodiment

An eighth embodiment of the invention is configured by combining the above-described first and fifth embodiments with each other. Namely, the electrode to which the electron multiplying pulse is applied is not fixed, the height of the electron multiplying pulse is made lower than that of a read pulse, and at least one, more preferably both, of rising and falling edges of the electron multiplying pulse is inclined. Also according to the configuration, the resistance of the CCD solid-state image pickup device is enhanced, and the reliability is improved.

### Ninth Embodiment

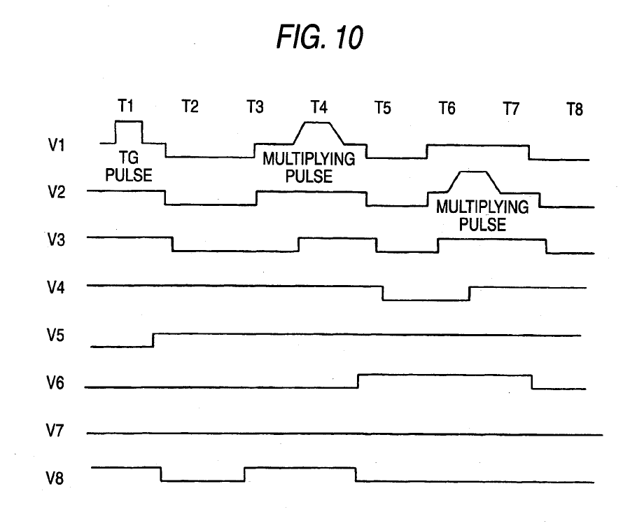

FIG. 10 is a chart illustrating a method of driving a CCD solid-state image pickup device of a ninth embodiment of the invention. The embodiment is configured by combining the above-described second and third embodiments with each other.

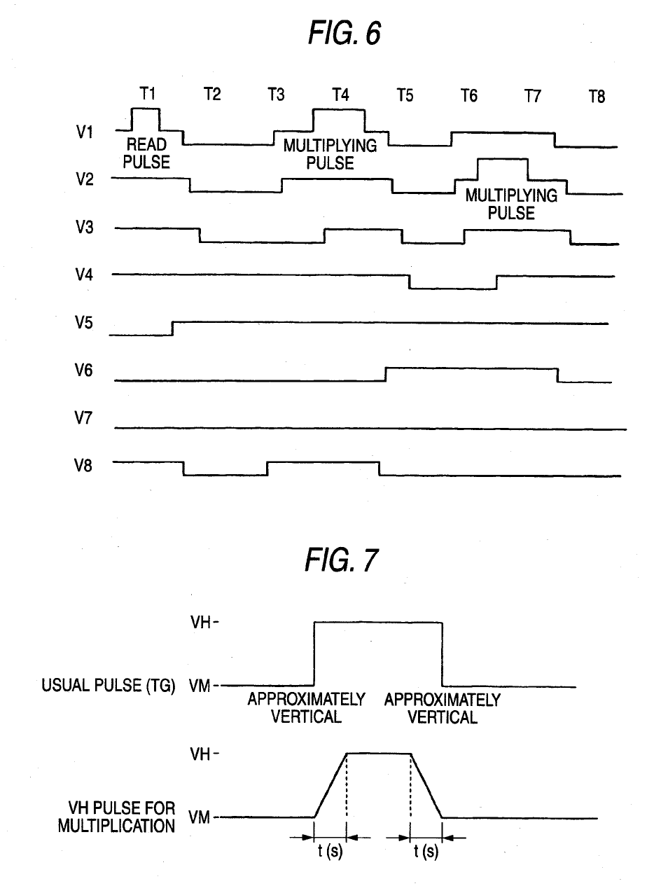

Namely, at least one, more preferably both, of rising and falling edges of the multiplying pulse shown in FIG. 6 is inclined, whereby a driving pulse for the vertical charge transfer path shown in FIG. 10 is produced.

According to the embodiment, in the CCD solid-state image pickup device in which pixels are arranged in a square lattice pattern, the electrode to which the electron multiplying pulse is applied is not fixed, and the edge(s) of the electron multiplying pulse is inclined so that the electric field is gently changed. Therefore, the resistance of the CCD solid-state image pickup device is enhanced, and the reliability is improved.

### Tenth Embodiment

A tenth embodiment of the invention is configured by combining the above-described second and fourth embodiments with each other. In the CCD solid-state image pickup device in which pixels are arranged in a square lattice pattern, the electrode to which the electron multiplying pulse is applied is not fixed, and the height of the electron multiplying pulse is made lower than that of a read pulse. Also according to the configuration, the resistance of the CCD solid-state image pickup device is enhanced, and the reliability is improved.

### Eleventh Embodiment

An eleventh embodiment of the invention is configured by combining the above-described second and fifth embodiments with each other. In the CCD solid-state image pickup device in which pixels are arranged in a square lattice pattern, the electrode to which the electron multiplying pulse is applied is not fixed, the height of the electron multiplying pulse is made lower than that of a read pulse, and at least one, more preferably both, of rising and falling edges of the electron multiplying pulse is inclined. Also according to the configuration, the resistance of the CCD solid-state image pickup device is enhanced, and the reliability is improved.

### Twelfth Embodiment

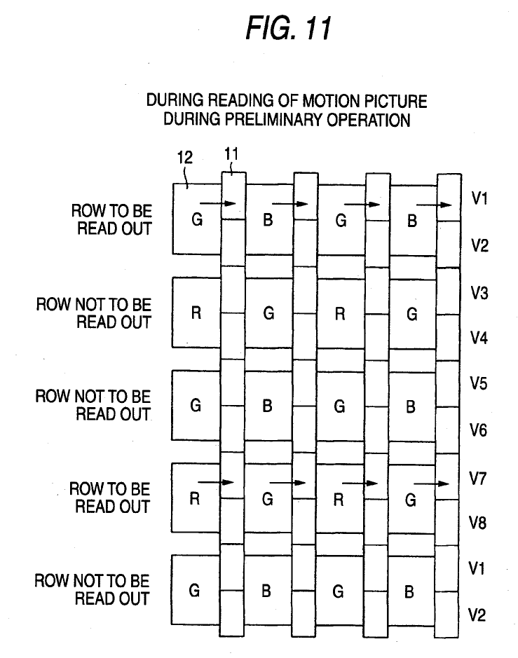

FIG. 11 is a diagram illustrating a method of driving a CCD solid-state image pickup device of a twelfth embodiment of the invention. In an image pickup apparatus on which a CCD solid-state image pickup device is mounted, such as a digital camera, usually, there are a still-picture imaging mode and a motion-picture imaging mode, and the user selects one of the modes. Even in the still-picture imaging mode, an autofocus process and an autoexposure process are performed as a preliminary operation before the still-picture imaging mode is actually conducted. During the preliminary operation, a taken-image signal is read out from the solid-state image pickup device in the same manner as the motion-picture imaging mode.

The embodiment relates to a driving method in the motion-picture imaging mode (including the preliminary operation). The illustrated pixel arrangement of the solid-state image pickup device is a square lattice arrangement, and color filters (R=red, G=green, B=blue) are arranged in a Bayer pattern.

The readout electrodes are the electrodes V1, V3, V5, V7. In the still-picture imaging mode, signal charges of all pixels are read out by the multi-field reading. In the motion-picture imaging mode, usually, signal charges are read out while performing pixel decimation. In the illustrated example, the reading out of signal charges to the vertical charge transfer path is performed only on every third pixel line.

In the motion-picture imaging mode, in each frame, the reading out of signal charges to the vertical charge transfer path is repeatedly performed on the readout pixel row. Namely, a read pulse of high voltage is repeatedly applied to the readout electrode of the pixel row.

In the embodiment, in the motion-picture imaging mode including the preliminary operation, therefore, an electrode adjacent to a pixel other than a readout row is used as the transfer electrode to which the electron multiplying pulse is to be applied. In the example shown in FIG. 11, the electrodes V3, V4, V5, V6 are electrodes adjacent to a pixel other than a readout row. The electrodes V3, V5 are used also as a readout electrode. When a high voltage is applied to these electrodes, signal charges in pixels are read out to the vertical charge transfer path. Therefore, the electron multiplication driving is performed while using one of the electrodes V4, V6 (the electrode may be fixed, or periodically switched over as in the first and second embodiments).

Alternatively, electron multiplication may be performed while the embodiment is combined with the other embodiment(s).

According to the configuration, the resistance of the CCD solid-state image pickup device is enhanced, and the reliability of the device is improved The embodiment can be applied not only to a CCD solid-state image pickup device of the square lattice arrangement, but also to a CCD solid-state image pickup device of the honeycomb pixel arrangement.

The above-described method of driving a CCD solid-state image pickup device is performed in the following manner. In an image pickup apparatus on which a CCD solid-state image pickup device is mounted, such as a digital camera, an image pickup device driving portion which drives and controls the CCD solid-state image pickup device, such as a timing generator produces a driving pulse such as shown in FIGS. 3, 6, 9, and 10, and supplies the driving pulse to the CCD solid-state image pickup device.

### Thirteenth Embodiment

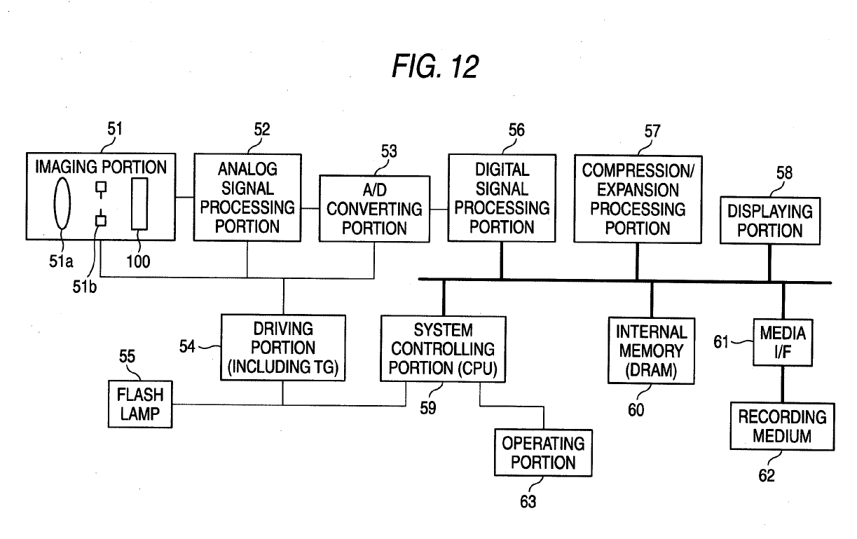

FIG. 12 is a functional block diagram of a highly reliable digital camera (image pickup apparatus) which executes the above-described method of driving a CCD solid-state image pickup device. The digital camera comprises: an imaging portion 51; an analog signal processing portion 52 which performs analog processes such as the automatic gain control (AGC) and the correlated double sampling process, on analog image data output from the imaging portion 51; an analog/digital converting portion (A/D) 53 which converts analog image data output from the analog signal processing portion 52 to digital image data; a driving portion (including a timing generator TG) 54 which drives and controls the A/D 53, the analog signal processing portion 52, and the imaging portion 51 in accordance with instructions from a controlling portion (CPU) 59 that will be described later; and a flash lamp 55 which emits light in accordance with instructions from the CPU 59.

The imaging portion 51 comprises: an optical lens system 51a which collects light incident from an object field; an aperture or a mechanical shutter 51b which converges the light that has passed through the optical lens system 51a; and a CCD solid-state image pickup device 100 which receives the light that has been collected by the optical lens system 51a and converged by the aperture, and which outputs taken-image data (analog image data).

The digital camera of the embodiment further comprises: a digital signal processing portion 56 which receives the digital image data output from the A/D 53, and which performs the interpolating process, the white balance correction, the RGB/YC converting process, and the like; a compression/expansion processing portion 57 which compresses image data to image data of the JPEG format or conversely expands image data; a displaying portion 58 which displays a menu, a through image, and a taken image; the system controlling portion (CPU) 59 which controls the whole of the digital camera; an internal memory 60 such as a frame memory; a media interface (I/F) portion 61 which performs an interface process with respect to a recording medium 62 that sores JPEG image data or the like; and a bus 70 which interconnects these portions. An operating portion 63 through which the user inputs instructions is connected to the system controlling portion 59.

In the thus configured digital camera, when the user input “highly sensitive imaging instruction” through the operating portions 63, for example, the CPU 59 instructs the driving portion 54 to perform electron multiplication. Then, the driving portion 54 produces the multiplying pulse which has been described in the embodiments, drives the CCD solid-state image pickup device 100 so that a very small amount of signal charges obtained in an imaging process is multiplied on the vertical charge transfer path, and outputs the multiplied signal charges.

As described above, even in the case where a solid-state image pickup device is not produced by a material having a high physical resistance to a high voltage, when an electrode to which a high-voltage pulse is to be applied, and the high-voltage pulse are improved as described above, places to which a high voltage (a read pulse and a multiplying pulse) is applied is not unevenly distributed, and hence stress concentration due to application of a high voltage can be avoided. Even in an existing CCD solid-state, image pickup device, therefore, electron multiplication can be easily performed, and highly sensitive imaging or the like is enabled.

Although the embodiments have been described by exemplifying a CCD solid-state image pickup device serving as an area sensor, the invention may be applied also to a line sensor.

### Fourteenth Embodiment

The digital camera of this embodiment is configured in a similar manner as the digital camera of the thirteenth embodiment. Moreover, the CCD solid-state image pickup device 40 shown in FIG. 12 is configured in a similar manner as the devices which have been described with reference to FIGS. 21A and 21B, and comprises: photodiodes (PDs: pixels) 12; vertical charge transfer paths (VCCD) 11 and horizontal charge transfer path (HCCD) 13 which transfer signal charges read out from the pixels 12; and an amplifier 14 which outputs a voltage signal corresponding to the amount of transferred signal charges, so that signal charges are electron-multiplied in the vertical charge transfer paths 11 under driving control of the driving portion 24.

Although not illustrated, in order to perform horizontal pixel addition, a buffer which is called a line memory (LM), and which temporarily stores signal charges received from the vertical charge transfer paths 11 and transfers the signal charges to the horizontal charge transfer path 13 may be sometimes disposed between end portions of the vertical charge transfer paths 11 and the horizontal charge transfer path 13, as described in, for example, JP-A-2002-112119.

Although, in the following, the CCD solid-state image pickup device having the configuration shown in FIG. 21A will be exemplarily described, the embodiment can be similarly applied also to the CCD solid-state image pickup device of FIG. 21B.

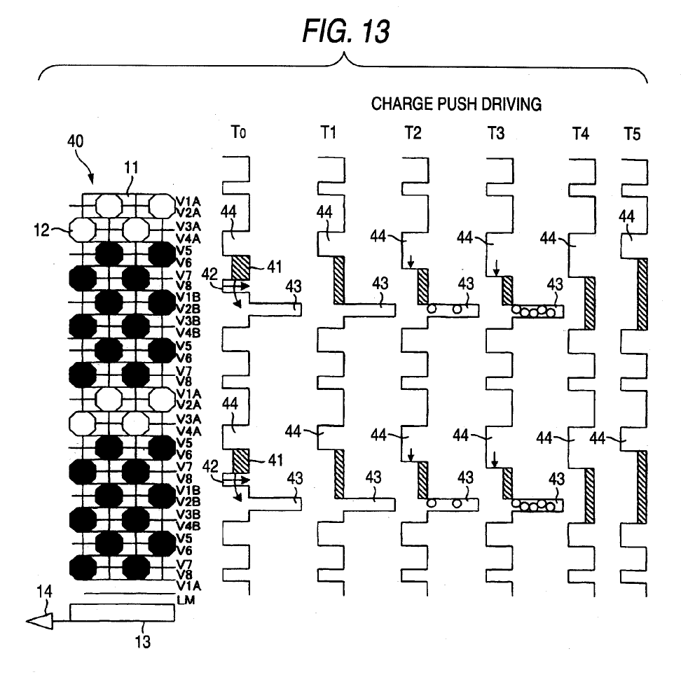

FIG. 13 is a timing chart illustrating a method of driving a CCD solid-state image pickup device of the fourteenth embodiment of the invention, and shows the state change of potential wells along vertical charge transfer paths in electron multiplication driving.

In the figure, a hollow octagon indicates a photodiode from which a signal charge has been read out to the vertical charge transfer path 11, and a solid octagon indicates a photodiode from which a signal charge has not been read out.

In the figure, a hollow circle in a potential well indicates a signal charge (in this example, electrons), and a hatched area indicates an area where a signal charge (electrons) exists.

In the figure, V1 to V8 denote transfer electrodes to which a transfer pulse φVi (i=1 to 8) is applied Each of pairs V1A and V1B, V2A and V2B, V3A and V3B, and V4A and V4B indicates that the same pulse is sometimes applied to corresponding electrodes, and different pulses are sometimes applied to the electrodes. In the electron multiplication driving, different pulses are applied to the electrodes.

Signal charges are read out from the photodiodes 12 respectively flanked on the transfer electrodes V1A, V2A, V3A, V4A, to the adjacent vertical charge transfer path 11. As shown in state T0, the signal charges are confined in a potential well 41 which is formed under the electrodes V6, V7, and a high voltage (for example, +15 V) is applied to the electrode V2B to form a deep potential well 43 under the electrode V2B.

Then, a barrier 42 (a barrier which is formed by applying a voltage of, for example, −8 V to the electrode V8) that divides between the potential well 41 which stores the signal charges, and which is formed under the electrodes V6, V7, and the deep potential well 43 under the electrode V2B is eliminated For example, the barrier is eliminated by setting the voltage applied to the electrode V8 to 0 V).

As shown in state T1, as a result, the signal charges in the potential well 41 flow toward the deep potential well 43, and fall into the potential well 43.

In states T0 and T1, in order to form the potential well 41, −8 V is applied to the electrodes V5, V4A, and the harrier 44 is formed. In next state T2, −8 V is applied also to the electrode V6 which is adjacent to the electrode V5 on the side of the potential well 43, thereby increasing the height of the barrier under the electrode V6. This causes the signal charges which flow toward the potential well 43, to be further pushed toward the potential well 43 by the barrier 44.

In next state T3, −8 V is applied also to the electrode V7 which is adjacent to the electrode V6 on the side of the potential well 43, thereby increasing the height of the barrier under the electrode V7. This causes the signal charges which flow toward the potential well 43, to be further pushed toward the potential well 43 by the barrier 44 to rapidly fall into the potential well 43. In this way, in electron multiplication, the driving is performed so that signal charges are pushed toward a deep potential well, and hence the time of multiplication driving can be shortened.

In the illustrated example, the pushing by the barrier 44 toward the potential well 43 is stopped with leaving a length corresponding to two electrodes or the electrodes V1B and V8. When the pushing by the barrier 44 is not stopped with leaving a length corresponding to at least one electrode, the potential difference between the electrode V2B for forming the potential well 43 and the electrode V1B adjacent to the electrode is excessively large (+15 V−(−8 V)=+23 V), thereby causing electrostatic breakdown. Therefore, the pushing by the barrier 44 to the vicinity of the potential well 43 is not performed.

In next state T4, this multiplication driving is ended, and hence the deep potential well is eliminated (the voltage applied to the electrode V2B is returned from +15 V to 0 V). In next state T5, the position of the barrier 44 is returned to under the electrodes V5, V4A. Then the state is returned to state T0, and the above-described operations are repeated.

In the above-described embodiment, when multiplication driving is performed by causing signal charges to fall into a deep potential well, the driving in which signal charges are pushed toward the potential well for multiplication is performed. Therefore, the multiplication driving can be performed for a short time, and the time of outputting a taken-image signal from the CCD solid-state image pickup device can be quickened.

### First Modification of Fourteenth Embodiment

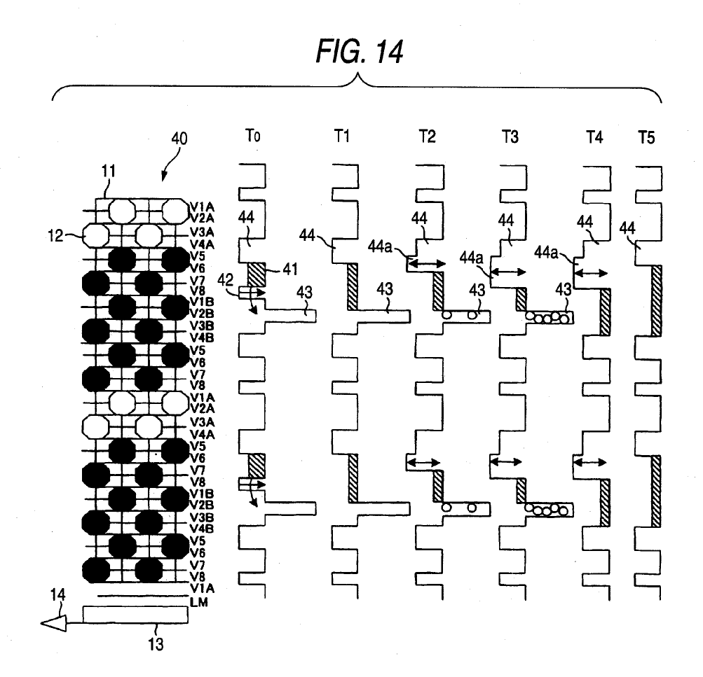

FIG. 14 is a chart showing a first modification of the method of driving a CCD solid-state image pickup device of the fourteenth embodiment which has been described with reference to FIG. 13. Hereinafter, only portions which are different from the embodiment of FIG. 13 will be described.

In the modification, when, in states T2 and T3, signal charges are push-driven toward the potential well 43, a barrier portion 44a of the harrier 44 used in the pushing, on the side of the potential well 43 is made slightly higher than the barrier 44. For example, a voltage of −9 V is applied to the electrode(s) forming the barrier portion 44a.

When this driving method is employed, the signal charges in the potential well 41 can be surely pushed toward the potential well 43.

### Second Modification of Fourteenth Embodiment

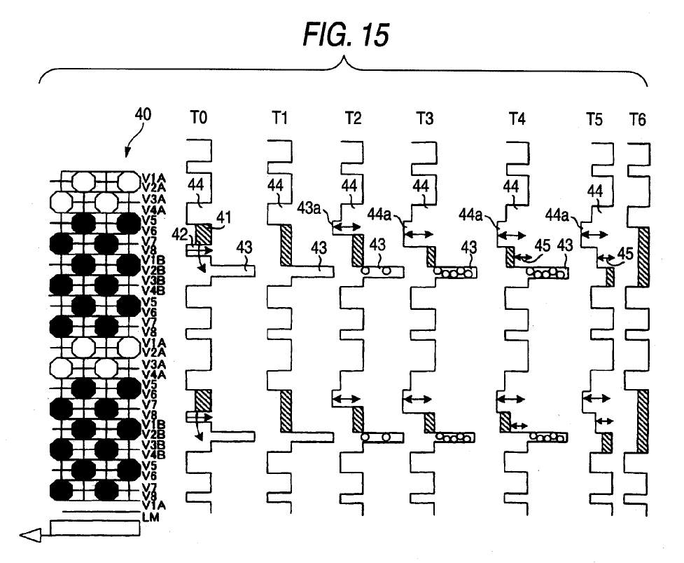

FIG. 15 is a chart showing another modification of the method of driving a CCD solid-state image pickup device of the modification which has been described with reference to FIG. 14. Hereinafter, only portions which are different from the modification of FIG. 14 will be described.

In the modification, the process which is performed until, in state T3, the barrier 44 is push-driven toward the potential well 43 and signal charges fall into the potential well 43 is identical with that of the fourteenth embodiment. As described also in state T3 of FIG. 2, when the pushing by the barrier 44 toward the potential well 43 is continued until it reaches the vicinity of the potential well 43, a high potential difference is generated between the electrodes V2B and V1B and hence this is not preferable. When the potential well of this portion 45 (under the electrodes V1B, V8) is shallowed (made higher with respect to the potential well 43), however, signal charges can be caused to fall more rapidly into the potential well 43.

In the modification, therefore, the potentials of the electrodes V1B, V8 are set to the level at which electrostatic breakdown does not occur, in state T4 subsequent to state T3. For example, the height of the barrier 44 is formed by applying −8 V to the corresponding electrodes. At this time, the voltage applied to the electrodes V1B, V8 is limited to, for example, −6 V or −4 V, thereby accelerating the rapid fall of signal charges into the potential well 43.

### Fifteenth Embodiment

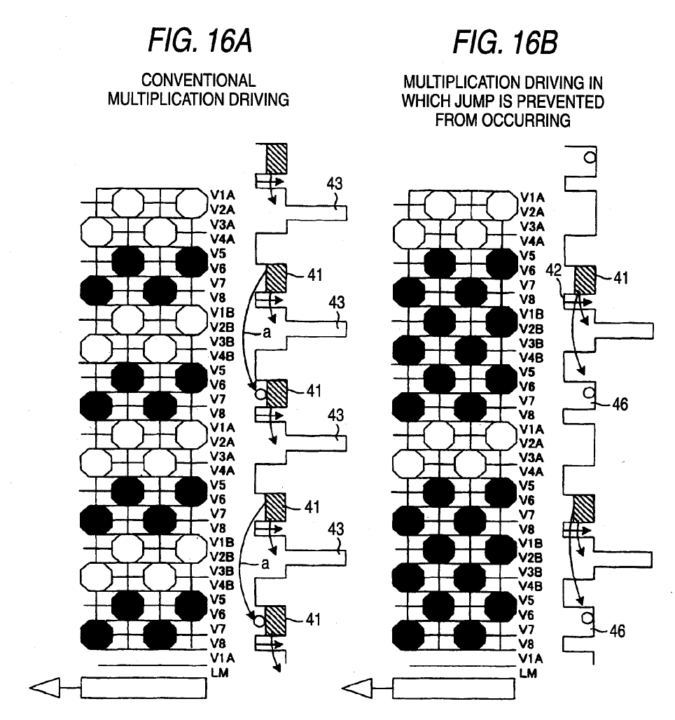

FIG. 16 is a timing chart illustrating a method of driving a CCD solid-state image pickup device of a fifteenth embodiment of the invention, FIG. 16A shows a conventional method, and FIG. 16B shows the method of the embodiment.

In the conventional driving method, electron multiplication is performed in the following manner. Accumulated electrons of photodiodes are read out to a vertical charge transfer path by the interlace method, signal charges are stored in the potential well 41 formed under the electrodes V6, V7 on the vertical charge transfer path, and the deep potential well 43 is formed under the electrodes V2A, V2B.

In this case, when the barrier between the potential wells 41, 43 is eliminated and electrons in the potential well 41 fall into the potential well 43, however, there is a possibility that some of the electrons jump into electrons in the potential well 41 in the precedent stage as shown by the arrow a in FIG. 16A. When electrons in the next stage are mixed into electrons in the precedent stage, color mixture and the like are caused. Therefore, it is impossible to obtain a taken-image signal which is highly accurate.

In the embodiment, therefore, a countermeasure for preventing mixture of electrons into the precedent stage is taken in the following manners The reading of signal charges from the photodiodes 12 is performed by 4-field reading. An empty packet 46 is previously disposed in a place where the mixture into the previous stage may possibly occur in electron multiplication. Electrons which jump over the deep potential well 43 toward the precedent stage are captured by the empty packet 46, and mixture of signal electrons into the stage two stages before is avoided.

The empty packet is illustrated also in FIGS. 13 to 15 showing the fourteenth embodiment. There is a possibility that the jump of electrons into the empty packet 46 occurs not only in elimination of the barrier 42, but also in the operation of pushing signal electrons by using the barrier 44. The disposition of the empty packet 46 is more effective in a combination with the fourteenth embodiment. However, the disposition is effective also in the case where it is applied to an electron multiplication driving method in which the pushing operation is not performed.

It is not preferable that electrons which are once captured into the empty packet 46 are moved to another empty potential well. Therefore, preferably, a high voltage is applied to the electrodes V6, V7 which form the empty packet 46 (the electrodes function also as electrodes for forming the potential well 41) so that a strong electric field is not produced above the empty packet.

After the multiplication driving, the electrons which are captured in the empty packet 46 are combined with the original electrons which have been multiplied, whereby the accuracy of a taken-image signal can be enhanced.

### Modification of Fifteenth Embodiment

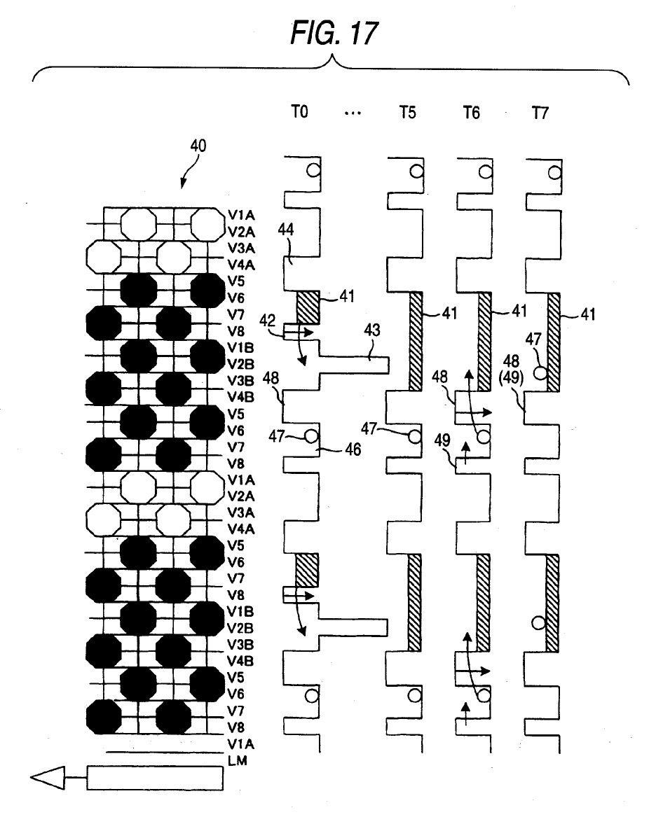

FIG. 17 is a timing chart illustrating a method of driving a CCD solid-state image pickup device of a modification of the fifteenth embodiment of the invention. In the driving method of the modification, the operation in which, after electron multiplication, the electrons in the empty packet 46 are combined with the multiplied electrons and the multiplication driving is again performed is repeated, thereby further enhancing the reliability of a taken-image signal.

FIG. 17 shows states T0 and T5 shown in FIG. 13, and subsequent states T6 and T7. States T1 to T4 in FIG. 17 are identical with those in FIG. 13 (except only that electrons are indicated in the empty packets).

In the illustrated example, when, in state T0, the barrier 42 is eliminated and electrons in the potential well 41 fall into the deep potential well 43, electrons 47 jump into the empty packet 46 with a certain probability. When electrons are pushed toward the potential well 43 in states T2 and T3 which are not shown in FIG. 17, alternatively, electrons 47 jump into the empty packet 46 with a certain probability.

In the embodiment, after state T4 transfers to state T5 and electron multiplication is ended, a barrier 48 (a barrier under the electrodes V5, V4B) which separates the potential well 41 storing the multiplied electrons from the empty packet 46 is eliminated, and a barrier 49 (a harrier under the electrode V8) which is on the opposite side of the empty packet 46 is moved toward the potential well 41 (state T6), whereby, as shown in state T7, the multiplied electrons and the electrons 47 in the empty packet 46 can be combined with each other in the potential well 41.

Then, the state is again returned to state T0, and the next electron multiplying operation is performed. According to the configuration, electron multiplication can be performed also on electrons which have jumped into an empty packet, and the accuracy of a taken-image signal can be further enhanced.

### Sixteenth Embodiment

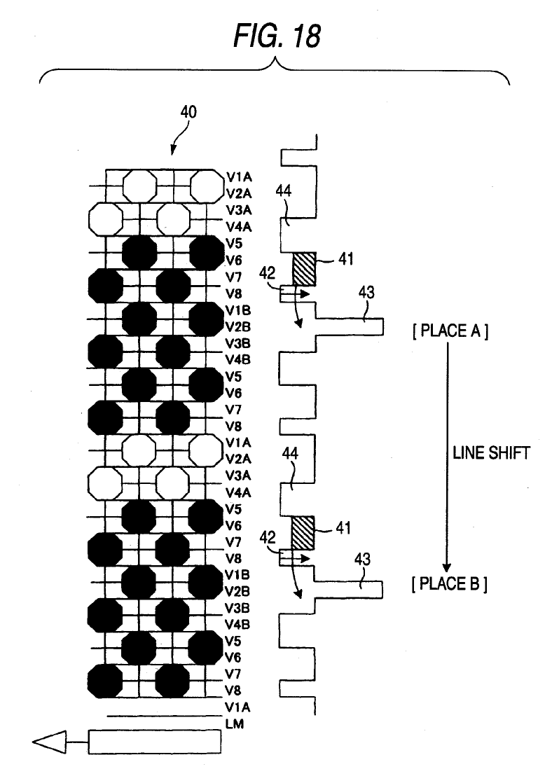

FIG. 18 is a chart illustrating a method of driving a CCD solid-state image pickup device of a sixteenth embodiment of the invention. In the case where electron multiplication driving is performed on a vertical charge transfer path of a CCD solid-state image pickup device, the multiplication factor is dispersed depending on a location When this dispersion is not suppressed, there is a possibility that the dispersed amount in superimposed on a taken-image signal and image quality is impaired.

As described in the embodiments above, the operation is repeated in which, after electron multiplication driving is performed by using the deep potential well 43 formed in a certain place A in the vertical charge transfer path, electros increased by the multiplication driving are shifted (transferred) to a place B of the next line (the transfer electrodes of the vertical charge transfer path consist of repetition of the electrodes V1 to V8, and the next line is a line configured by the subsequent electrodes V1 to V8), and electron multiplication driving is performed by using the deep potential well 43 formed in the place B.

The line shift may be conducted each time electron multiplication is performed one time. Alternatively, the operation may be repeated in which electron multiplication driving is performed a predetermined number of times in a certain place, and electron multiplication driving is again performed the predetermined number of times in the next line-shifted place.

As described above, electron multiplication driving is repeated while line-shifting the place where the driving. In the embodiment, therefore, a dispersion of the multiplication factor depending on a place can be suppressed, and fixed pattern noises can be reduced.

### Seventeenth Embodiment

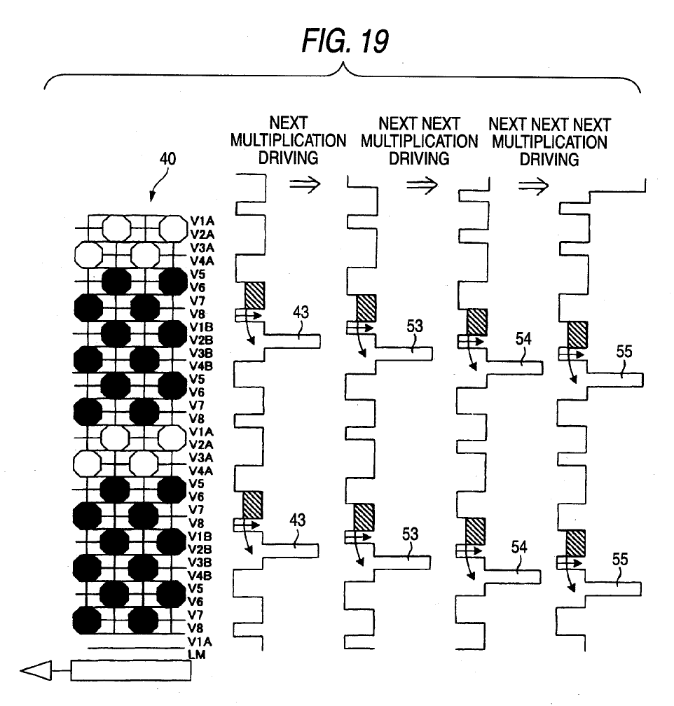

FIG. 19 is a chart illustrating a method of driving a CCD solid-state image pickup device of a seventeenth embodiment of the invention. In the above-described fourteenth embodiment of FIG. 13, electron multiplication driving is performed many times by using the deep potential well 43 formed under the electrode V2B.

In the embodiment, by contrast, an operation is repeated in which, as shown in FIG. 19, first electron multiplication driving is performed by using the deep potential well 43 formed under the electrode V2B, next electron multiplication driving is performed by using a deep potential well 53 formed under the adjacent electrode V3B, and then next next electron multiplication driving is performed by using a potential well 54 formed under the adjacent electrode V4B.

In the case where electron multiplication driving is repeated 100 times, the transfer electrode to which a high voltage is applied in order to form a deep potential well may be sequentially switched over on the same line. In place that the position where the deep potential well is formed is switched over each time the driving is performed, the position may be switched over each time the driving is performed a predetermined plural number of times. Alternatively, the embodiment may be combined with the above-described sixteenth embodiment so that electrodes for forming a deep potential well are switched over while performing the line-shift.

According to the configuration, fixed pattern noises can be reduced to (1/√N) as compared with the case where electron multiplication driving is repeated in the same place.

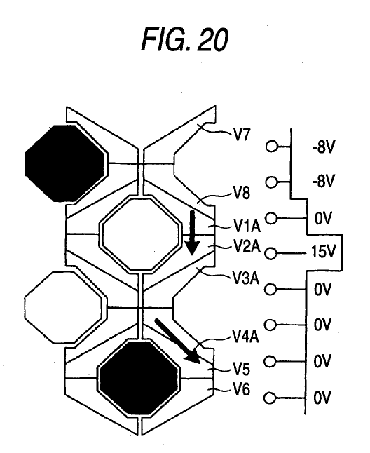

FIG. 20 is a diagram illustrating the effect of the seventeenth embodiment, and a partial enlarged view of FIG. 21A. Unlike FIG. 21B, the transfer electrodes V1 to V8 have boundary portions (for example, between the electrodes V1A and V2A) where adjacent electrodes are vertically contacted with each other, and other boundary portions (for example, between the electrodes V4A and V5) where adjacent electrodes are obliquely contacted with each other.

The route of charge movement in multiplication driving, particularly, the potential difference in the interface through which electrons fall a deep potential well largely affects the electron multiplication factor. This is caused by the phenomenon that, even when the same voltages are applied to electrodes, the potential difference between electrodes across a boundary or the electric field strength is different depending on whether the boundary is formed vertically or obliquely.

When, as in the seventeenth embodiment, the place (electrodes) where multiplication driving is performed is moved each time electron multiplication is performed or each time electron multiplication is performed a predetermined number of times, the electrode dependency of the electron multiplication factor can be eliminated, and a uniform electron multiplication factor can be obtained.

The above description is directed to the example shown in FIG. 21A. Also in the CCD solid-state image pickup device shown in FIG. 21B, the electron multiplication factor is different depending on whether electrodes for forming a potential well are those functioning also as a readout electrode or those dedicated to transfer.

An electrode which functions also as a readout electrode is formed so as to be suitable for application of the readout voltage which is a high voltage. Therefore, a high voltage can be readily applied to such an electrode, and a deep potential well can be easily formed. By contrast, an electrode dedicated to transfer is formed on the assumption that a high voltage is not applied. Even in the case where the same high voltage is applied, therefore, the depth of a formed potential well is different from that formed by an electrode which functions also as a readout electrode.

Also in the CCD solid-state image pickup device of FIG. 21B, therefore, the application of the seventeenth embodiment is effective, fixed pattern noises can be reduced, and the location dependency of the electron multiplication factor can be reduced.

Although the first to seventeenth embodiments have been individually described, it is a matter of course that, when plural or all of the embodiments are applied to driving of a CCD solid-state image pickup device, the stability, reliability, accuracy, noise reduction, and the like of electron multiplication driving can be further enhanced.

According to the driving method of the present invention, the resistance to electron multiplication can be enhanced, and, even when electron multiplication is performed, the reliability of the device can be improved. Therefore, the method is useful in application to a CCD solid-state image pickup device which is mounted on a digital camera or the like.

Moreover, according to the driving method of the present invention, the electron multiplication can be performed for a short time and accurately, the location dependency of the electron multiplication factor can be reduced, and fixed pattern noises due to the location dependency of the electron multiplication factor can be reduced. Therefore, the method is useful as a method of driving a CCD solid-state image pickup device which is mounted on a digital camera that performs highly sensitive imaging.

This application is based on and claims priority under 35 U.S.C. 119 from Japanese Patent Application No. 2007-160199 filed Jun. 19, 2007, Japanese Patent Application No. 2007-256224 filed Sep. 28, 2007, Japanese Patent Application No. 2007-256226 filed Sep. 28, 2007 and Japanese Patent Application No. 2007-256227 filed Sep. 28, 2007.

What is claimed is:

1. A method of driving a CCD solid-state image pickup device, which performs multiplication driving on the signal charges, the method comprising:
reading out signal charges from a plurality of photoelectric converting elements that are arranged in a two-dimensional array-like pattern to a charge transfer path that is disposed in parallel to a photoelectric converting element column of the photoelectric converting elements; and
applying a multiplying pulse to a multiplying electrode among transfer electrodes constituting the charge transfer path,
wherein
an electrode, which is set as the multiplying electrode among the transfer electrodes, is periodically changed.

2. The method as claimed in claim 1,
wherein
at least one of rising and falling edges of the multiplying pulse is more inclined than an edge of a read pulse which is applied to a readout electrode in a case where signal charges are read out from the photoelectric converting elements.

3. The method as claimed in claim 1,
wherein
the multiplying pulse has a height being lower than a height of a read pulse applied in the reading out of the signal charge.

4. The method as claimed in claim 1,
wherein
a transfer electrode adjacent to a photoelectric converting element from which a signal charge is read out, and which is empty is used as the multiplying electrode.

5. The method as claimed in claim 1,
wherein
a transfer electrode, which is not a readout electrode adjacent to a photoelectric converting element that is not an object of reading a signal charge in a case where a motion picture is read out, is used as the multiplying electrode.

6. A method of driving a CCD solid-state image pickup device which performs multiplication driving on the signal charges, the method comprising:
reading out signal charges from a plurality of photoelectric converting elements that are arranged in an array-like pattern to a charge transfer path that is disposed in parallel to a photoelectric converting element column of the photoelectric converting elements; and
applying a multiplying pulse to a multiplying electrode among transfer electrodes constituting the charge transfer path,
wherein
at least one of rising and falling edges of the multiplying pulse is inclined.

7. The method as claimed in claim 6,
wherein
the multiplying pulse has a height being lower than a height of a read pulse which is applied in a case where signal charges are read out from the photoelectric converting elements to the charge transfer path.

8. A method of driving a CCD solid-state image pickup device which performs multiplication driving on signal charges, the method comprising:
reading out the signal charges from a plurality of photoelectric converting elements that are arranged in an array-like pattern to a charge transfer path that is disposed in parallel to a photoelectric converting element column of the photoelectric converting elements; and
applying a multiplying pulse to a multiplying electrode among transfer electrodes constituting the charge transfer path,
wherein
a transfer electrode adjacent to a photoelectric converting element from which a signal charge is read out, and which is empty is used as the multiplying electrode.

9. A method of driving a CCD solid-state image pickup device, which performs multiplication driving on the signal charges, the method comprising:
reading out signal charges from a plurality of photoelectric converting elements that are arranged in a two-dimensional array-like pattern to a charge transfer path that is disposed in parallel to a photoelectric converting element column of the photoelectric converting elements; and
applying a multiplying pulse to a multiplying electrode among transfer electrodes constituting the charge transfer path,
wherein
a transfer electrode, which is not a transfer electrode adjacent to a photoelectric converting element that is not an object of reading a signal charge in a case where a motion picture is read out, is used as the multiplying electrode.

10. An image pickup apparatus comprising
a CCD solid-state image pickup device; and
an image pickup device driving unit that produces a multiplying pulse according to claim 1, and supplies the multiplying pulse to the CCD solid-state image pickup device.

11. The image pickup apparatus as claimed in claim 10,
wherein
the CCD solid-state image pickup device is a line sensor.

12. The image pickup apparatus as claimed in claim 10,
wherein
the CCD solid-state image pickup device is an area sensor.

13. The image pickup apparatus as claimed in claim 12,
wherein
a pixel arrangement of the CCD solid-state image pickup device is a honeycomb pixel arrangement.

14. The image pickup apparatus as claimed in claim 12,
wherein
a pixel arrangement of the CCD solid-state image pickup device is a square lattice arrangement.

15. A method of driving a CCD solid-state image pickup device, which performs multiplication driving on signal charges, the method comprising:
reading out signal charges from a plurality of photoelectric converting elements that are arranged in a two-dimensional array-like pattern to a charge transfer path that is disposed in parallel to a photoelectric converting element column of the photoelectric converting elements;
storing the signal charges in a first potential well between first and second potential barriers formed in the charge transfer path;
forming a multiplication potential well which is deeper than the first potential well by applying a multiplication voltage to a multiplication electrode, which is a predetermined electrode which is among transfer electrodes constituting the charge transfer path and is at a position beyond the first potential barrier; and
eliminating the first potential barrier to cause the signal charges in the first potential well to fall into the multiplication potential well,
wherein
a voltage, which is applied to the transfer electrode that forms the second potential barrier, is controlled so that, in a case where the first potential barrier is eliminated to cause the signal charges to tall into the multiplication potential well, the signal charges are pushed toward the multiplication potential well by using the second potential barrier.

16. The method as claimed in claim 15,
wherein,
in the pushing of the signal charges, a voltage, which is applied to the transfer electrode to form a barrier end portion of the second potential barrier on the side of the signal charges, is controlled to make a barrier height of the barrier end portion higher than a barrier height of the second potential barrier.

17. The method as claimed in claim 15,
wherein,
in the pushing of the signal charges, a voltage, which is applied to the transfer electrode to define a depth of a well between a barrier end portion of the second potential barrier on the side of the signal charges and the multiplication potential well, is controlled to raise the depth of the well to a level which is lower than the second potential barrier.

18. The method as claimed in claim 15,
wherein
an empty second potential well is formed in a place which is beyond the multiplication potential well as viewed from the first potential well.

19. The method as claimed in claim 18,
wherein
a high voltage for forming the multiplication potential well is not applied to the transfer electrode for forming the second potential well.

20. The method as claimed in claim 18,
wherein
the multiplied signal charges and a signal charge in the second potential well are added to each other.

21. The method as claimed in claim 18,
wherein,
after the multiplied signal charges and a signal charge in the second potential well are added to each other, the multiplication is again performed.

22. The method as claimed in claim 15,
wherein,
in a case where successive transfer electrodes Vi, Vi+1, Vi+2, . . . , Vi+j to which transfer pluses φVi, φVi+1, φVi+2, . . . , φVi+j are respectively applied are set as a transfer electrode group for one line, i and j are arbitrary, and the transfer electrode group is repeatedly disposed over a plurality of lines along the charge transfer path, after the multiplication potential well is formed in a certain one of the lines to perform the multiplication and the signal charges after the multiplication are transferred to a next line in a direction of the transfer, the multiplication potential well is formed in the next line and the multiplication is again performed.

23. The method as claimed in claim 15,
wherein,
in a case where successive transfer electrodes Vi, Vi+1, Vi+2, . . . , Vi+j to which transfer pluses φVi, φVi+1, φVi+2, . . . , φVi+j are respectively applied are set as a transfer electrode group for one line, i and j are arbitrary, and the transfer electrode group is repeatedly disposed over a plurality of lines along the charge transfer path, after the multiplication potential well is formed in a certain one of the lines to perform the multiplication, the multiplication is repeatedly performed while switching over the multiplication electrode which forms the multiplication potential well, in the lines.

24. An image pickup apparatus comprising:
a CCD solid-state image pickup device; and
an image pickup device driving unit that drives the CCD solid-state image pickup device by a driving method according to claims 15.

25. A method of driving a COD solid-state image pickup device, which performs multiplication driving on signal charges, the method comprising:
reading out signal charges from a plurality of photoelectric converting elements that are arranged in a two-dimensional array-like pattern to a charge transfer path that is disposed in parallel to a photoelectric converting element column of the photoelectric converting elements;
storing the signal charges in a first potential well between first and second potential barriers formed in the charge transfer path;
forming a multiplication potential well which is deeper than the first potential well by applying a multiplication voltage to the multiplication electrode, which is a predetermined electrode which is among transfer electrodes constituting the charge transfer path and is at a position beyond the first potential barrier; and
eliminating the first potential barrier to cause the signal charges in the first potential well to fall into the multiplication potential well,
wherein
the falling of the signal charges is performed by forming an empty second potential well in a place which is beyond the multiplication potential well as viewed from the first potential well.

26. The method as claimed in claim 25,
wherein
a high voltage which forms the multiplication potential well is not applied to the transfer electrode which forms the second potential well.

27. The method as claimed in claim 25,
wherein
the multiplied signal charges and a signal charge in the second potential well are added to each other.

28. The method as claimed in claim 25,
wherein,
after the multiplied signal charges and a signal charge in the second potential well are added to each other, the multiplication is again performed.

29. The method as claimed in claim 25,
wherein,
in a case where successive transfer electrodes Vi, Vi+1, Vi+2, . . . , Vi+j to which transfer pluses φVi, φVi+1, φVi+2, . . . , Vi+j are respectively applied are set as a transfer electrode group for one line, i and j are arbitrary, and the transfer electrode group is repeatedly disposed over a plurality of lines along the charge transfer path, after the multiplication potential well is formed in a certain one of the lines to perform the multiplication and the signal charges after the multiplication are transferred to a next line in a direction of the transfer, the multiplication potential well is formed in the next line and the multiplication is again performed.

30. The method as claimed in claim 25,
wherein,
in a case where successive transfer electrodes Vi, Vi+1, Vi+2, . . . , to which transfer pluses φVi, φVi+1, φVi+2, . . . , φVi+j are respectively applied are set as a transfer electrode group for one line, i and j are arbitrary, and the transfer electrode group is repeatedly disposed over a plurality of lines along the charge transfer path, after the multiplication potential well is formed in a certain one of the lines to perform the multiplication, the multiplication is repeatedly performed while switching over the multiplication electrode which forms the multiplication potential well, in the lines.

31. An image pickup apparatus comprising:
a CCD solid-state image pickup device; and
an image pickup device driving unit that drives the CCD solid-state image pickup device by a driving method according to claim 25.

32. A method of driving a CCD solid-state image pickup device, which performs multiplication driving on signal charges, the method comprising:
reading out signal charges from a plurality of photoelectric converting elements that are arranged in a two-dimensional array-like pattern to a charge transfer path that is disposed in parallel to a photoelectric converting element column of the photoelectric converting elements;
storing the signal charges in a first potential well between first and second potential barriers formed in the charge transfer path;
forming a multiplication potential well which is deeper than the first potential well by applying a multiplication voltage to the multiplication electrode, which is a predetermined electrode which is among transfer electrodes constituting the charge transfer path and is at a position beyond the first potential barrier; and
eliminating the first potential barrier to cause the signal charges in the first potential well to fall into the multiplication potential well,
wherein,
in a case where successive transfer electrodes Vi, Vi+1, Vi+2, . . . , φVi+j to which transfer pluses φVi, φVi+1, φVi+2, . . . , φVi+j are respectively applied are set as a transfer electrode group for one line, i and j are arbitrary, and the transfer electrode group is repeatedly disposed over a plurality of lines along the charge transfer path, after the multiplication potential well is formed in a certain line to perform the multiplication and the signal charges after the multiplication are transferred to a next line in a direction of the transfer, the multiplication potential well is formed in the next line and the multiplication is again performed.

33. The method as claimed in claim 32,
wherein,
after the multiplication potential well is formed in a certain one of the lines to perform the multiplication, the multiplication is repeatedly performed while switching over the multiplication electrode which forms the multiplication potential well, in the lines.

34. A method of driving a CCD solid-state image pickup device, which performs multiplication driving on signal charges, comprising:
reading out signal charges from a plurality of photoelectric converting elements that are arranged in a two-dimensional array-like pattern to a charge transfer path that is disposed in parallel to a photoelectric converting element column of the photoelectric converting elements;
storing the signal charges in a first potential well between first and second potential barriers formed in the charge transfer path;
forming a multiplication potential well which is deeper than the first potential well by applying a multiplication voltage to the multiplication electrode, which is a predetermined electrode which is among transfer electrodes constituting the charge transfer path and is at a position beyond the first potential barrier; and
eliminating the first potential barrier to cause the signal charges in the first potential well to fall into the multiplication potential well,
wherein,
in a case where successive transfer electrodes Vi, Vi+1, Vi+2, . . . , Vi+j to which transfer pluses φVi, φVi+1, φVi+2, φVi+j are respectively applied are set as a transfer electrode group for one line, i and j are arbitrary, and the transfer electrode group is repeatedly disposed over a plurality of lines along the charge transfer path, after the multiplication potential well is formed in a certain one of the lines to perform the multiplication, the multiplication is repeatedly performed while switching over the multiplication electrode which forms the multiplication potential well, in the lines.

35. An image pickup apparatus comprising:
a CCD solid-state image pickup device; and
an image pickup device driving unit that drives the COD solid-state image pickup device by a driving method according to claim 32.
